(19) United States
(12) Patent Application Publication
(10) Pub. No.: US 2003/0081877 A1
(43) Pub. Date: May 1, 2003

(54) Optical circuit and manufacturing method of the same

(75) Inventors: Hidehiko Nakata, Kawasaki (JP); Mitsunori Abe, Kawasaki (JP); Tadao Inoue, Kawasaki (JP)

Correspondence Address: ARMSTRONG,WESTERMAN & HATTORI, LLP, 1725 K STREET, NW, SUITE 1000, WASHINGTON, DC, 20006, US

(73) Assignee: Fujitsu Limited, Kawasaki (JP)

(21) Appl. No.: 10/103,811

(22) Filed: Mar. 25, 2002

(30) Foreign Application Priority Data
Oct. 29, 2001 (JP) 2001-331190

(51) Int. Cl. G02B 6/12

(52) U.S. Cl. 385/14

(57) ABSTRACT

An optical circuit including an optical wave-guiding channel and a mirror formed on a slope forming a predetermined angle with a substrate, the slope being formed by reflowing a silica glass layer accumulated on a step that is substantially perpendicular to the substrate. The optical circuit optically connects the optical wave-guiding channel and an optical active device fixed over the mirror even if the optical axis of the optical wave-guiding channel forms an angle with that of the optical active device.

### BACKGROUND OF THE INVENTION

1. Field of the Invention

The present invention generally relates to an optical circuit and a manufacturing method of the same, and more particularly, to the structure of an optical circuit that connects an optical waveguiding channel and an optical active device (such as a photo detector or a photo emitter) that are formed on a silicon substrate, for example, where an optical axis of the optical wave-guiding channel forms an angle with that of the photo detector.

2. Description of the Related Art

The recent increase in network communications demands high-capacity communication apparatuses. High capacity optical networks based on a wavelength division multiplexing (WDM) system are being built as one of the most preferable solutions. A planar light wave circuit (PLC) type device integrated functional component is expected to materialize a small-sized, low cost WDM transmission system when manufactured in mass production.

Various structures that optically connect an optical wave-guiding channel and a photo active device with these techniques are proposed. The Japanese patent No. 2970519, for example, describes a structure in which a light beam outgoing through the edge face of an optical wave-guiding channel is totally reflected to the upward direction by a slope forming an angle of about 45° with the light beam as showed in FIG. 1. The 45° slope is formed on a Si substrate by forming a 54.7° slope through an anisotropic etching in this case. A silica glass layer is accumulated (reflow) on the 54.7° slope to make it a slope forming an angle of about 45° with the light beam and a mirror is formed on the silica glass layer. Compared with micro-optics in which the optical wave-guiding channel and the photo active device are bound by arranging optical lenses, the structure is small-sized and cost effective.

The Japanese laid-open patent application No. 7-191236 describes a technique in which, after forming an optical wave-guiding channel, a portion which becomes a reflective mirror and a perpendicular edge face through which the light beam goes out are formed and the reflective slope is formed by performing a reflow on the portion. That is, according to this technique, the reflective slope is formed by performing a reflow on the only portion having a step that is substantially perpendicular to the substrate.

According to the above technique, however, the reflective slope has been formed by performing anisotropic etching on Silicon (Si) substrate before the forming of the optical wave-guiding channel. The Si substrate on which the optical wave-guiding channel is formed has a step of tens of μm, which makes uniformly forming a silica glass layer to form the optical wave-guiding channel difficult. Although a core layer needs to be processed at an accuracy of +/−0.3-0.1 μm or less in order to form an optical wave-guiding channel of high performance, the step tends to make the accuracy of the processing low.

Additionally, since an anisotropic etching must be performed, it is impossible to use a silica glass substrate, instead of a Si substrate, that has a coefficient of thermal expansion close to that of the silica glass optical wave-guiding channel in order to reduce stress in the optical wave-guiding channel (the stress makes the properties of the optical wave-guiding channel depend on the polarization of the light beam), for example.

Another problem of the related art is that the forming of the reflective slope requires processes such as anisotropic etching of the substrate and exposing a Si slope after forming the optical wave-guiding channel.

According to the method described in the Japanese laid-open patent application No. 7-191236, it is necessary to heat up only the portion where a reflective mirror is to be formed in order not to damage the accurate perpendicular edge face through which the light beam goes out by performing a reflow on the entire silica glass layers (an under-clad layer, a core layer, and an over-clad layer) and heating up the entire wafer. The heating up of only the portion, however, makes processes using semiconductor manufacturing equipment complicated, which results in low efficiency.

Furthermore, the above method requires three additional processes to realize the structure in which the light beam goes out in the direction perpendicular to the optical wave-guiding channel and is complicated, the three additional processes being the forming process, after the forming process of the optical wave-guiding channel, of the portion to become the reflective mirror and the perpendicular edge face through which the light beam goes out, the reflow process, and the forming process of the reflective face on the slope.

Because the edge face of the core layer through which the light beam goes out is exposed to air, the light signal may contain noise due to undesirable reflection on the edge face. An additional process in which the light path between the edge face and the optical device is filled with material such as resin that has a refraction index close to that of the core layer is required, which makes the processes more complicated. If the light path is filled with the resin as described above, the risk of debonding of the resin from the glass surface and/or degradation of the resin must be taken into account.

### SUMMARY OF THE INVENTION

Accordingly, it is a general object of the present invention to provide a novel and useful optical circuit in which one or more of the problems described above is eliminated.

Another and more specific object of the present invention is to provide an optical circuit that realizes a simple manufacturing process, a high manufacturing efficiency, and a high reliability, and a manufacturing method of the same.

To achieve one of the above objects, an optical circuit according to the present invention includes a substrate, an optical wave-guiding channel formed on a top face of the substrate, a step unit that is substantially perpendicular to the top face of the substrate, a slope formed on the step unit, the slope forming a predetermined angle with the substrate, and a mirror formed on the slope.

Compared with an optical circuit according to the related art in which a substrate itself is etched to form a step, and a layer is accumulated and reflowed on the step after an optical waveguiding channel is formed on the top face of the substrate, the optical circuit according to the present invention can be manufactured by a simpler process. It is easy to form the optical wave-guiding channel at a sufficient accuracy on the optical circuit according to the present invention because the substrate does not have any step. Furthermore, since the anisotropic etching on the substrate is not required, the substrate can be selected from various materials.

By selecting the material of the layer having relatively lower reflow temperature, the flatness of the edge face of the optical waveguiding channel, through which the light beam goes out, is not damaged by the heat of the reflow. Because the substrate is not required to be heated locally, the manufacturing process of the optical circuit according to the present invention can be simplified.

Additionally, the optical circuit according to the present invention is characterized in that the slope is made of silica glass material. Because the slope made of the silica glass material is covered by another silica glass material of the same kind, the light beam going out of the edge face of the optical wave-guiding channel is not distorted at the boundary face by refraction, for example.

Furthermore, the optical circuit according to the present invention is further characterized in that the step and the optical wave-guiding channel are made of an identical material. The step and the optical wave-guiding channel can be formed in the same process simultaneously, which results in the simplifying of the manufacturing process.

Because a step substantially perpendicular to the top face of the substrate can be formed in the etching process in which the optical waveguiding channel core pattern is formed, the manufacturing process is further simplified.

Other objects, features, and advantages of the present invention will become more apparent from the following detailed description when read in conjunction with the accompanying drawings.

### BRIEF DESCRIPTION OF THE DRAWINGS

FIG. 1 is a sectional view showing a structure of an optical circuit according to the related art;

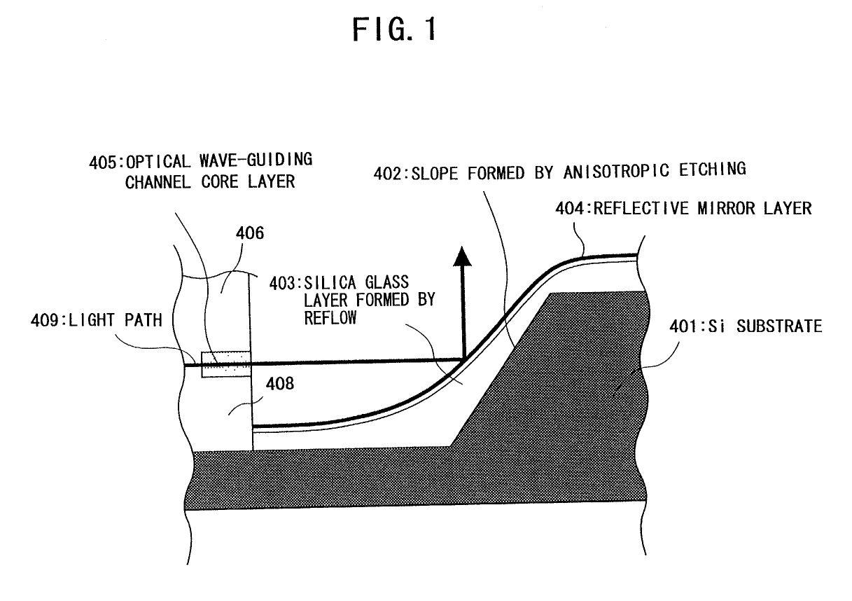

FIGS. 2A-2F are schematic drawings showing the respective steps of the manufacturing process of an optical circuit according to the first embodiment of the present invention;

FIGS. 3A-3H are schematic drawings showing the respective steps of the manufacturing process of an optical circuit according to the second embodiment of the present invention;

FIGS. 4A and 4B are schematic drawings showing the respective steps of the manufacturing process of an optical circuit according to the third embodiment of the present invention; and

FIGS. 5A-5G are schematic drawings showing the respective steps of the manufacturing process of an optical circuit according to the fourth embodiment of the present invention.

### DETAILED DESCRIPTION OF THE PREFERRED EMBODIMENTS

The preferred embodiments of the present invention will be described below by reference to drawings.

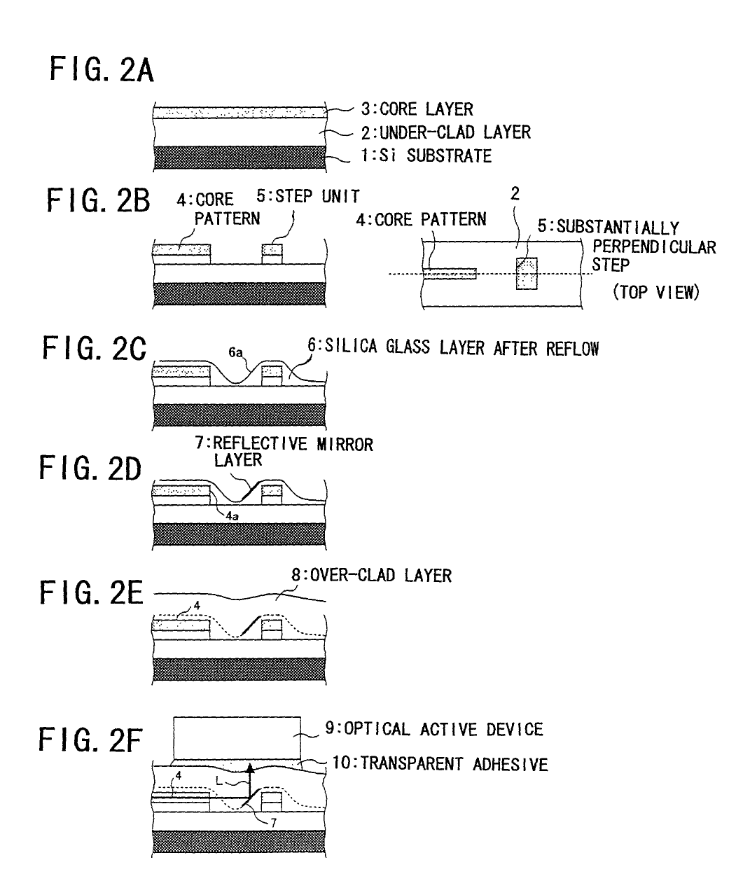

FIGS. 2A-2F are schematic drawings showing the respective manufacturing steps of an optical circuit according to the first embodiment of the present invention.

In the first step showed in FIG. 2A, an under-clad layer 2 is formed on a Si substrate 1 (a silica glass substrate that has the coefficient of thermal expansion close to the optical wave-guiding channel to be formed on the substrate is also usable), and a core layer 3 having a smaller refraction index than the under-clad layer 2. The layers can be made by a method such as chemical vapor deposition (CVD), flame hydrolysis deposition (FHD), or spattering.

In the second step showed in FIG. 2B, a core pattern 4 and a substantially perpendicular step 5 that become the core of the wave-guiding channel are formed by etching the core layer 3 in the same manner as the conventional method. This etching process must be performed by reactive ion etching (RIE) at a high accuracy using metal masks. The preferable etching depth is about 1.5 times the height of core layer 3. A top view is also showed in FIG. 2B.

In the third step showed in FIG. 2C, a silica glass layer 6 having a smaller refraction index than the core layer 3 is accumulated at a depth of about a half of the etching depth, and then, the silica glass layer 6 is planarized by a reflow method of 880° C., for 2 hours to form a slope 6a forming an angle of about 45°. The silica glass layer 6 to be accumulated is made of silica glass having a lower melting point than the under-clad layer 2 and the core layer 3 in order to avoid the thermal transformation of the core pattern 4 during the reflow and consequent degradation of waveguiding channel properties.

The following materials are usable for the respective layers. B, P-dope silica glass (BPSG) having a relatively lower melting point, in which boron is doped, is used for the silica glass layer 6. G, P-dope silica glass (GPSG) having a relatively high melting point is used for the under-clad layer 2 and the core layer 3.

In the fourth step showed in FIG. 2D, a reflective mirror layer 7 having a high reflection index is formed on the slope 6a facing to the edge face 4a of the core pattern. This mirror layer is a metal layer formed by deposition or sputtering, for example. The metal material of the mirror layer can be any material having a higher melting point than the reflow temperature of the above BPSG, such as Ti, Au, or Si. Accordingly, the degradation of the mirror caused by high temperature during the forming of the over-clad layer 8 can be avoided.

In the fifth step showed in FIG. 2E, the over-clad layer 8 is formed to cover the mirror 7.

In the sixth step showed in FIG. 2F, an optical active device 9 that is to be connected to the optical wave-guiding channel (the core pattern 4) is fixed over the mirror layer 7. The optical active device 9 is fixed with adhesive material that is transparent and has substantially the same refraction index as the over-clad layer 8 in order to increase the quantity of the light signal output from the over-clad layer 8 and input to the optical active device 9. The optical active device 9 can be fixed by soldering if the portion where the light signal passes through is filled with a transparent resin, for example.

According to the embodiment as described above, since the core pattern 4 that is used for forming the wave-guiding channel and the substantially perpendicular step 5 that is used when the substantially 45° slope 6a for forming the reflective mirror layer 7 is formed are simultaneously formed, no additional step in which only the step 5 is formed to form the slope 6a is required. The embodiment does not require any special process or manufacturing equipment to form the step 5, which results in the simplification of the entire manufacturing process. Since the over-clad layer 8 and the silica glass layer 6 forming the slope 6a under the over-clad layer 8 are made of materials having substantially the same refraction index, the light beam L is not distorted at the boundary by refraction, for example.

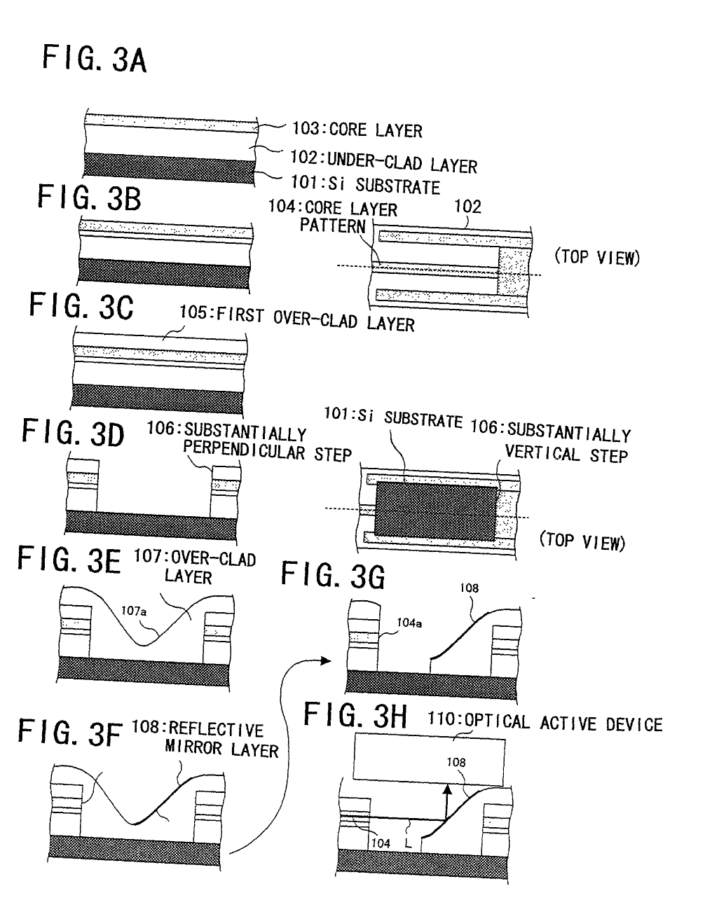

The manufacturing process of the second embodiment of the present invention is described by reference to FIGS. 3A-3H.

In the first step showed in FIG. 3A, an under-clad layer 102 made of silica glass layer is formed on a Si substrate 101 (a silica glass substrate that has the coefficient of thermal expansion close to the optical wave-guiding channel to be formed on the substrate is usable as well), and a core layer 103 having a higher refraction index than the under-clad layer 102 is formed. The layers can be formed by CVD, FHD, or sputtering, for example.

In the second step shown in FIG. 3B, a core pattern 104 that becomes a wave-guiding channel core by etching the core layer 101 in the same manner as the conventional method. As showed in the top view in FIG. 3B, rectangular spaces are removed by etching in order to accumulate adhesive material, for example, in the rectangular spaces in the following steps.

In the third step shown in FIG. 3C, an over-clad layer 105 having about half the thickness of the entire over-clad layer is formed, using a material having a smaller refraction index than the core layer 103.

In the fourth step showed in FIG. 3D, the first over-clad layer 105, the core layer 103, and an under-clad layer 102 are etched until the Si substrate 101 is exposed. A top view is also showed in FIG. 3D.

In the fifth step showed in FIG. 3E, a second over-clad layer 107 is accumulated and a slope 107a forming an angle of substantially 45° is formed by performing a reflow process.

In the sixth step showed in FIG. 3F, a reflective mirror layer 108 having a high reflective index is formed on the slope 107a facing to the edge face 104a of the core pattern 104.

In the seventh step showed in FIG. 3G, the edge face 104a facing to the reflective mirror layer 108 is exposed by etching by the RIE method, and the perpendicular edge face of the wave-guiding channel is formed.

In the eighth and last step as showed in FIG. 3H, an optical active device 110 that is optically connected with the optical wave-guiding channel 104 is fixed over the mirror layer 108 in order to lead the light beam L going out of the wave-guided channel into the optical active device 110. The other components that are not explained above are the same as those of the first embodiment.

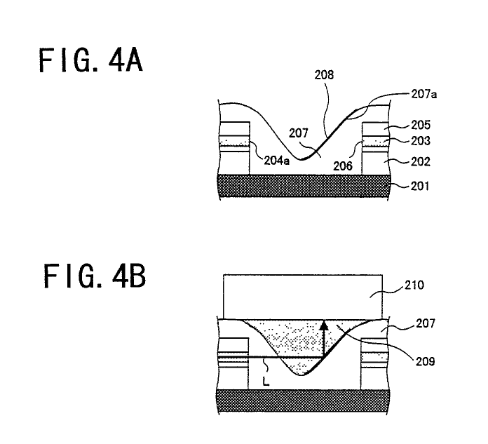

The third embodiment of the present invention is now described by reference to FIGS. 4A and 4B.

FIGS. 4A and 4B are schematic drawings showing the respective steps of the manufacturing process according to the third embodiment.

In this manufacturing process according to this embodiment, because the steps before a reflective mirror layer 208 is formed are the same as the first through sixth steps of the second embodiment described above by reference to FIGS. 3A-3F (FIG. 3F corresponds to FIG. 4A), the figures and the description corresponding to those steps are omitted.

After forming the mirror layer 208, when an optical active device 210 that is optically connected with the optical wave-guiding channel is fixed over the mirror layer 208 in the second step as showed in FIG. 4B, the space between the optical active device 210 and the mirror layer 208 is filled with adhesive material 209 having substantially the same refractive index as the over-clad layer 207, which results in efficient optical connection between the optical active device 210 and the waveguiding channel 204.

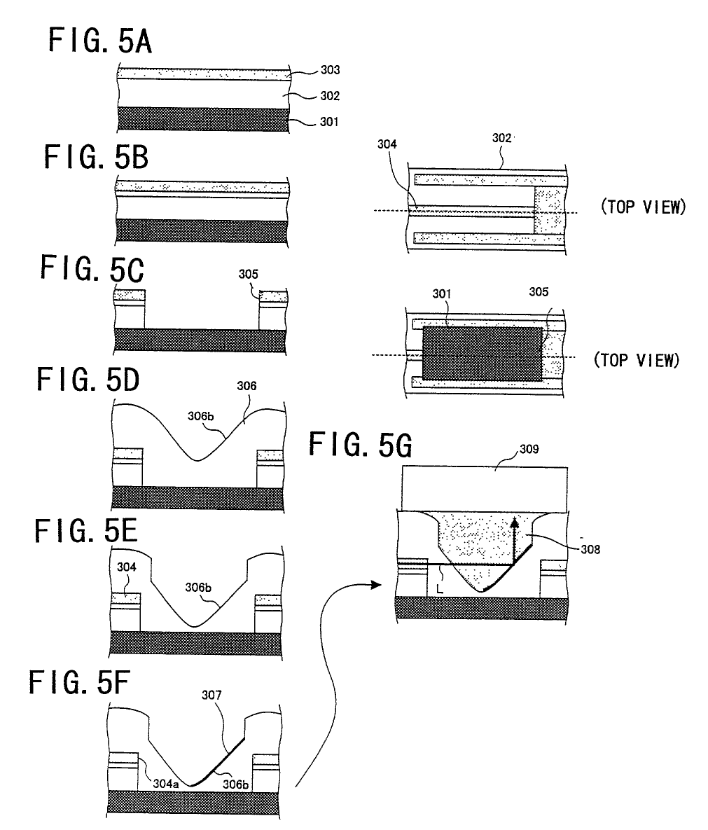

The fourth embodiment of the present invention is described by reference to FIGS. 5A-5G.

FIGS. 5A-5G are schematic drawings showing the manufacturing process of the fourth embodiment.

In the first step showed in FIG. 5A, a silica glass under-clad layer 302 is formed on a Silicon (Si) substrate 301 (a silica glass substrate that has the coefficient of thermal expansion close to the optical wave-guiding channel to be formed on the substrate is usable as well), and a core layer 303 made by material having a higher refraction index than the under-clad layer 302 is formed on the under-clad layer 302. The layers can be formed by a CVD method, FHD method, or sputtering method, for example.

In the second step as showed in FIG. 5B, a core pattern 304 that becomes a wave-guiding channel core is formed by etching the core layer 301 in the same manner as the conventional method. A top view is also showed in FIG. 5B.

In the third step showed in FIG. 5C, predetermined portions of the core layer 303 and the under-clad layer 302 are etched until the Si substrate is exposed. A top view is also showed in FIG. 5C.

In the fourth step showed in FIG. 5D, the over-clad layer 306 is accumulated and a slope 306b forming an angle of about 450 is formed by processing the over-clad layer 306 by reflow.

Next in the fifth step as showed in FIG. 5E, the vertical position (height) of the 45° slope 306b formed in the over-clad layer 306 is lowered by uniformly etching the slope 306b so that the 45° slope is exposed to the light beam outgoing from the wave-guiding core 304 (transfer process).

In the sixth step as showed in FIG. 5F, a reflective mirror layer 307 having a high reflection index is formed on the slope 306b facing the edge face 304a of the core pattern.

Finally, in the seventh step showed in FIG. 5G, an optical active device 309 is fixed over the mirror layer 307 to optically connect with the optical wave-guiding channel 304. The space between the optical active device 309 and the mirror layer 307 on the slope 306b is filled with adhesive material 308 having substantially the same refractive index as that of the over-clad layer 306 in order to efficiently transfer the light beam outgoing from the over-clad layer 306 to the optical active device 309.

In the above description, it is assumed that the optical wave-guiding channel and the layer forming the slope are made of silica glass material, but any material besides silica glass is usable as long as the material is transparent and has physical properties suitable for a reflow process.

In summary, according to the present invention, a step unit substantially perpendicular to the top face of the substrate is formed first, and then, a slope is formed by reflowing a layer accumulated on the step. The mirror is formed on the slope. The vertical position (height) of the slope is lowered by etching uniformly (transfer process). Compared with the conventional technique in which a slope is formed on a Si substrate by anisotropic etching, a step that is substantially perpendicular to the top face of the substrate is formed on a substrate. Accordingly, because anisotropic etching is not necessary, the substrate material is not limited to Si, but can be selected from a wide variety of materials including silica glass in order to improve the properties of the optical circuit.

The step substantially perpendicular to the top face of the substrate can be formed by processing layers that are formed on the substrate to form the optical wave-guiding channel. The step can be processed by photo-lithography and RIE, which improve the accuracy of the processing and simplify the manufacturing process of the optical circuit.

Additionally, the step substantially perpendicular to the top face of the substrate can be formed simultaneously when the core pattern of the optical wave-guiding channel is formed by etching, which further simplifies the manufacturing process.

Furthermore, because a layer having substantially the same refractive index as the slope is formed in the space over the mirror, the light beam goes out of the optical wave-guiding channel straight to the mirror. The manufacturing process can be simplified without sacrificing the optical properties of the optical circuit.

Since the reflow temperature of the layers accumulated to form the optical wave-guiding channel and the step unit substantially perpendicular to the substrate is higher than that of the layer to be accumulated and reflowed, the layers accumulated to form the optical wave-guiding channel are not damaged even if the entire substrate is heated. Therefore, it is not necessary to heat only portions of the substrate locally, which makes the manufacturing process simpler.

According to the present invention, the step unit substantially perpendicular to the top face of the substrate and the edge face of the waveguiding channel are formed in the manufacturing process in which a wave-guiding channel pattern is formed by etching the core layer as showed in FIG. 2B, for example. Additionally, it is possible to simultaneously perform both annealing (a process in which the silica glass layer accumulated by a CVD is heated to let water go out of the silica glass layer in order to improve the quality of the silica glass layer) and forming the slope forming an angle of substantially 45° with the substrate by reflowing as shown in FIG. 2D, for example. By adding only a process to form the mirror on the slope as shown in FIG. 2D, for example, the optical circuit according to the present invention that changes the optical path of the light beam going out of the optical wave-guiding channel horizontally to the optical path incoming vertically to the optical active device can be realized.

Since the mirror on the slope of the optical circuit according to the present invention can be formed during the process in which the optical wave-guiding channel is formed, the space over the mirror can be filled up with an over-clad layer. No additional process to fill up the space with resin is required. The over-clad layer made of a material such as silica glass fills up the light path from the edge face of the optical wave-guide channel and the optical active device that is optically connected, which increases the reliability of the optical circuit.

The preferred embodiments of the present invention are described above. The present invention is not limited to these embodiments, but various variations and modifications may be made without departing from the scope of the present invention.

This patent application is based on Japanese priority patent application No. 2001-331190 filed on Oct. 29, 2001, the entire contents of which are hereby incorporated by reference.

What is claimed is:

1. An optical circuit, comprising:
a substrate;
an optical wave-guiding channel formed on a top face of said substrate;
a step unit that is substantially perpendicular to said top face of said substrate;
a slope formed on said step unit, said slope forming a predetermined angle with said substrate; and
a mirror formed on said slope.

2. The optical circuit as claimed in claim 1, wherein said slope is made of silica glass material.

3. The optical circuit as claimed in claim 1, wherein said step unit and said optical waveguiding channel are made of an identical material.

4. The optical circuit as claimed in claim 1, further comprising an over-clad layer formed on said mirror and said optical wave-guiding channel.

5. The optical circuit as claimed in claim 4, wherein said mirror is made of a mirror material having a higher melting point than a material of which said over-clad layer is made.

6. The optical circuit as claimed in claim 4, wherein said step unit is made of a step material having a higher melting point than a slope material of which said slope is made.

7. The optical circuit as claimed in claim 1, wherein the width of said step unit is wider than the width of said optical wave-guiding channel.

8. The optical circuit as claimed in claim 1, wherein an edge face of said optical wave-guiding channel is opposed by said step.

9. The optical circuit as claimed in claim 1, wherein a space between said mirror a nd an optical active device that is fixed over said mirror is filled with transparent material.

10. An optical circuit having a mirror formed on a slope forming a predetermined angle with a substrate, wherein
said slope is formed by reflowing a first layer accumulated on a step that is substantially perpendicular to said substrate.

11. The optical circuit as claimed in claim 10, wherein a height of said slope is reduced by etching after the reflow.

12. The optical circuit as claimed in claim 10, wherein said step is formed by an etching process that forms an optical wave-guiding core pattern.

13. The optical circuit as claimed in claim 10, wherein
an optical wave-guiding channel is formed by accumulating an under-clad layer and an over-clad layer; and
both reflow temperatures of said under-clad layer and said over-clad layer are higher than a reflow temperature of said slope.

14. The optical circuit as claimed in claim 13, wherein an edge face of said optical waveguiding channel is made perpendicular to said substrate by a reactive ion etching.

15. A method of manufacturing an optical circuit, comprising:
a step of forming a core pattern and a step unit that is substantially perpendicular to a top face of a substrate simultaneously by etching;
a step of accumulating a first layer on said core pattern and said step unit;
a step of forming a slope by reflowing said first layer; and
a step of forming a mirror on said slope.

16. The method as claimed in claim 15, further comprising a step of reducing a height of said slope by etching uniformly.
